(19) United States
(12) Patent Application Publication
(10) Pub. No.: US 2008/0163214 A1
(43) Pub. Date: Jul. 3, 2008

(54) Online task monitoring tool

(75) Inventor: Karen Cochran Rogers, Murfreesboro, TN (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/646,459

(22) Filed: Dec. 28, 2006

(51) Int. Cl. G06F 9/46

(52) U.S. Cl. 718/100

(57) ABSTRACT

A system for a task monitoring tool is provided. The computer system has a platform, at least one input device, and a central processing unit in communication with the platform and the at least one input device. The central processing unit is configured to display one or more tasks using an electronic passport and receive input indicating a completion of the task. The central processing unit is further configured to indicate the task as complete in the electronic passport.

### TECHNICAL FIELD

The present disclosure is directed to the field of task monitoring and, more particularly, to an online task monitoring tool.

### BACKGROUND

People often use a scheduler to keep a list of tasks that need to be performed, including any associated due dates for the tasks. One example of a scheduler is a small notebook that includes a calendar. The person that will perform the tasks may create and add those tasks to the scheduler, or another person may assign the tasks. For example, a company or supervisor may assign a number of tasks to an employee and provide the employee with a calendar notebook including due dates for each task.

While a calendar style notebook may help employees to organize and schedule tasks, these notebooks quickly become outdated and increase the costs of a company. For example, if a meeting is rescheduled, the employee must manually update the notebook to reflect the new meeting time. In addition, the company must purchase notebooks for each employee and for each series of tasks assigned to the employees. Companies would prefer to assign tasks to employees electronically in a manner that allows monitoring of the task status and provides easy task updating.

One tool that has been developed for assigning and tracking tasks electronically is U.S. patent application Publication No. 2002/0087382 A1 by Triburcio (the '382 publication). The '382 publication describes a system and method for computer-aided task monitoring. A user may view a list of assigned tasks using an electronic interface, complete the tasks, and receive notification on the electronic interface when the tasks are complete. Other users can also monitor the status of the assigned tasks, and the system may send automatic reminders as tasks approach their due dates. The electronic interface of the '382 publication also provides a link to web pages that provide instructions for completing tasks.

Although the tool of the '382 publication may offer an electronic interface for assigning and tracking tasks, it fails to provide a simple, intuitive graphical user interface that users will readily understand. Users that do not readily understand the user interface may overlook tasks that need to be completed or simply refuse to use the system. As a result, users might need training on how to use the tracking tool of the '382 publication, causing increased costs and delay to a company. Accordingly, the method employed by the '382 publication fails to provide a simple, intuitive graphical user interface for assigning and tracking tasks.

The present disclosure is directed to overcoming one or more of the problems set forth above.

### SUMMARY OF THE INVENTION

In accordance with one aspect, the present disclosure is directed toward a computer readable medium, tangibly embodied, including an online task monitoring tool. The computer readable medium includes instructions for displaying one or more tasks using an electronic passport and receiving input indicating completion of the task. The computer readable further includes instructions for indicating the task as complete in the electronic passport.

According to another aspect, the present disclosure is directed toward a method for providing an online task monitoring tool. The method includes displaying one or more tasks using an electronic passport and receiving input indicating completion of the task. The method further includes indicating the task as complete in the electronic passport.

According to another aspect, the present disclosure is directed to a computer system including a platform, at least one input device, and a central processing unit in communication with the platform and the at least one input device. The central processing unit is configured to display one or more tasks using an electronic passport and receive input indicating completion of the task. The central processing unit is further configured to indicating the task as complete in the electronic passport.

### BRIEF DESCRIPTION OF THE DRAWINGS

FIG. 1 is a block illustration of an exemplary disclosed online task monitoring system;

FIG. 2 is a flowchart illustration of an exemplary disclosed method of monitoring tasks;

FIG. 3 is a schematic illustration of a first exemplary disclosed user interface for monitoring tasks;

FIG. 4 is a schematic illustration of a second exemplary disclosed user interface for monitoring tasks;

FIG. 5 is a schematic illustration of a third exemplary disclosed user interface for monitoring tasks; and

FIG. 6 is a schematic illustration of a fourth exemplary disclosed user interface for monitoring tasks.

### DETAILED DESCRIPTION

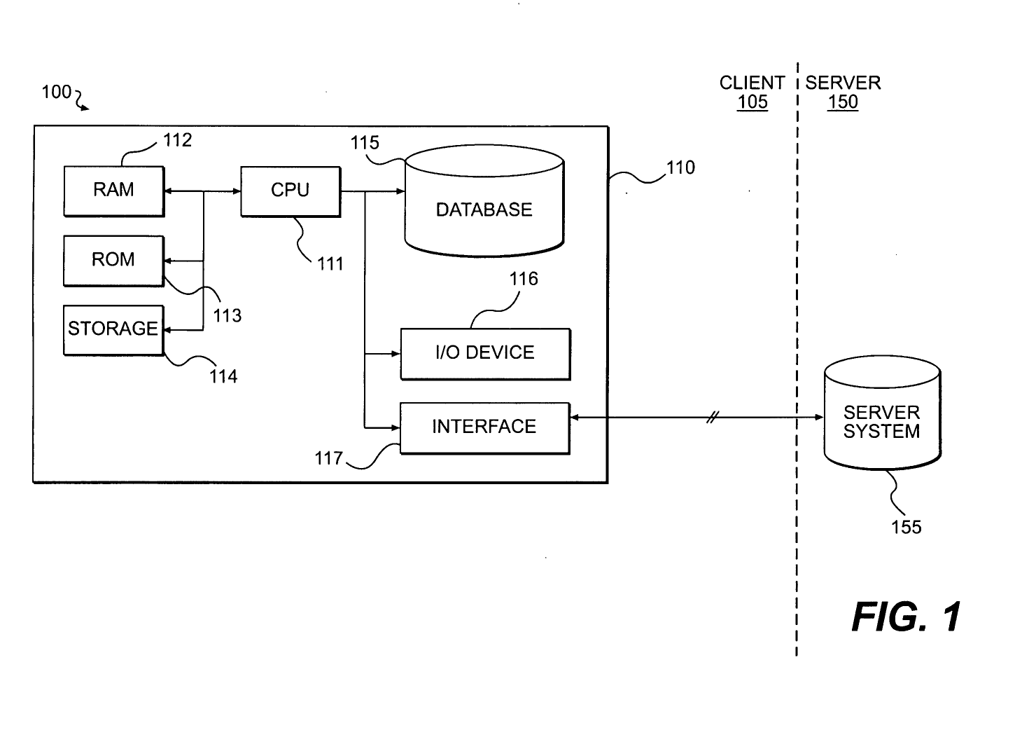

FIG. 1 provides a block diagram illustrating an exemplary task monitoring environment 100. Task monitoring environment 100 may include a client 105 and server 150. Server 150 may include one or more server databases 155 for generating a graphical user interface that client 105 may use to monitor and complete tasks. Client 105 may include, for example, an employee of a company, and server 150 may include, for example, another employee of the company that assigns one or more tasks to client 105. Although illustrated as a single client 105 and a single server 150, a plurality of clients 105 may be connected to either a single, centralized server 150 or a plurality of distributed servers 150.

System 110 may include any type of processor-based system on which processes and methods consistent with the disclosed embodiments may be implemented. For example, as illustrated in FIG. 1, system 110 may be a platform that includes one or more hardware and/or software components configured to execute software programs. System 110 may include one or more hardware components such as a central processing unit (CPU) 111, a random access memory (RAM) module 112, a read-only memory (ROM) module 113, a storage 114, a database 115, one or more input/output (I/O) devices 116, and an interface 117. System 110 may include one or more software components such as a computer-readable medium including computer-executable instructions for performing methods consistent with certain disclosed embodiments. One or more of the hardware components listed above may be implemented using software. For example, storage 114 may include a software partition associated with one or more other hardware components of system 110. System 110 may include additional, fewer, and/or different components than those listed above, as the components listed above are exemplary only and not intended to be limiting.

CPU 111 may include one or more processors, each configured to execute instructions and process data to perform one or more functions associated with system 110. As illustrated in FIG. 1, CPU 111 may be communicatively coupled to RAM 112, ROM 113, storage 114, database 115, I/O devices 116, and interface 117. CPU 111 may execute sequences of computer program instructions to perform various processes, which will be described in detail below. The computer program instructions may be loaded into RAM for execution by CPU 111.

RAM 112 and ROM 113 may each include one or more devices for storing information associated with an operation of system 110 and CPU 111. RAM 112 may include a memory device for storing data associated with one or more operations of CPU 111. For example, ROM 113 may load instructions into RAM 112 for execution by CPU 111. ROM 113 may include a memory device configured to access and store information associated with system 110, including information for creating and monitoring one or more tasks.

Storage 114 may include any type of mass storage device configured to store information that CPU 111 may need to perform processes consistent with the disclosed embodiments. For example, storage 114 may include one or more magnetic and/or optical disk devices, such as hard drives, CD-ROMs, DVD-ROMs, or any other type of mass media device.

Database 115 may include one or more software and/or hardware components that cooperate to store, organize, sort, filter, and/or arrange data used by system 110 and CPU 111. Database 115 may store an electronic task scheduler received from server 150. CPU 111 may access the information stored in database 115 for monitoring the status of one or more tasks.

I/O devices 116 may include one or more components configured to communicate information with a user associated with system 110. For example, I/O devices may include a console with an integrated keyboard and mouse to allow a user to input parameters associated with system 110. I/O devices 116 may also include a display, such as a monitor, including a graphical user interface (GUI) for outputting information. I/O devices 116 may also include peripheral devices such as, for example, a printer for printing information and reports associated with system 110, a user-accessible disk drive (e.g., a USB port, a floppy, CD-ROM, or DVD-ROM drive, etc.) to allow a user to input data stored on a portable media device, a microphone, a speaker system, or any other suitable type of interface device.

The results of received data may be provided as an output from system 110 to I/O device 116 for printed display, viewing, and/or further communication to other system devices. Such an output may include the status of a task (e.g., scheduled or completed). Output from system 110 can also be provided to database 115 and to server system 155.

Interface 117 may include one or more components configured to transmit and receive data via a communication network, such as the Internet, a local area network, a workstation peer-to-peer network, a direct link network, a wireless network, or any other suitable communication platform. In this manner, system 110 and server system 155 may communicate through the use of a network architecture (not shown). In such an embodiment, the network architecture may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. For example, interface 117 may include one or more modulators, demodulators, multiplexers, demultiplexers, network communication devices, wireless devices, antennas, modems, and any other type of device configured to enable data communication via a communication network.

Server 150 may be a company, manufacturer, supplier, or distributor that assigns one or more tasks to client 105 using server system 155. Server system 155 may allow creation of tasks, assignment of tasks to employees, monitoring of the status of tasks, validation of completion of tasks, and updating of itineraries to reflect completion of tasks. For example, server 150 may be a company that assigns a series of tasks to a newly hired employee (client 105). Server system 155 may provide an online graphical user interface to client 105 for completing the tasks. The online graphical user interface may include an itinerary that displays a due date for the assigned tasks as well as a completion date for the tasks, as described in more detail below. Although not illustrated, server system 155 may include similar components as described above with respect to client system 110.

Those skilled in the art will appreciate that all or part of systems and methods consistent with the present disclosure may be stored on or read from other computer-readable media. Task monitoring environment 100 may include a computer-readable medium having stored thereon machine executable instructions for performing, among other things, the methods disclosed herein. Exemplary computer readable media may include secondary storage devices, like hard disks, floppy disks, and CD-ROM; or other forms of computer-readable memory, such as read-only memory (ROM) 113 or random-access memory (RAM) 112. Such computer-readable media may be embodied by one or more components of task monitoring environment 100, such as CPU 111, storage 113, database 115, server system 155, or combinations of these and other components.

Furthermore, one skilled in the art will also realize that the processes illustrated in this description may be implemented in a variety of ways and include other modules, programs, applications, scripts, processes, threads, or code sections that may all functionally interrelate with each other to provide the functionality described above for each module, script, and daemon. For example, these programs modules may be implemented using commercially available software tools, using custom object-oriented code written in the C++ programming language, using applets written in the Java programming language, or may be implemented with discrete electrical components or as one or more hardwired application specific integrated circuits (ASIC) that are custom designed for this purpose.

The described implementation may include a particular network configuration but embodiments of the present disclosure may be implemented in a variety of data communication network environments using software, hardware, or a combination of hardware and software to provide the processing functions.

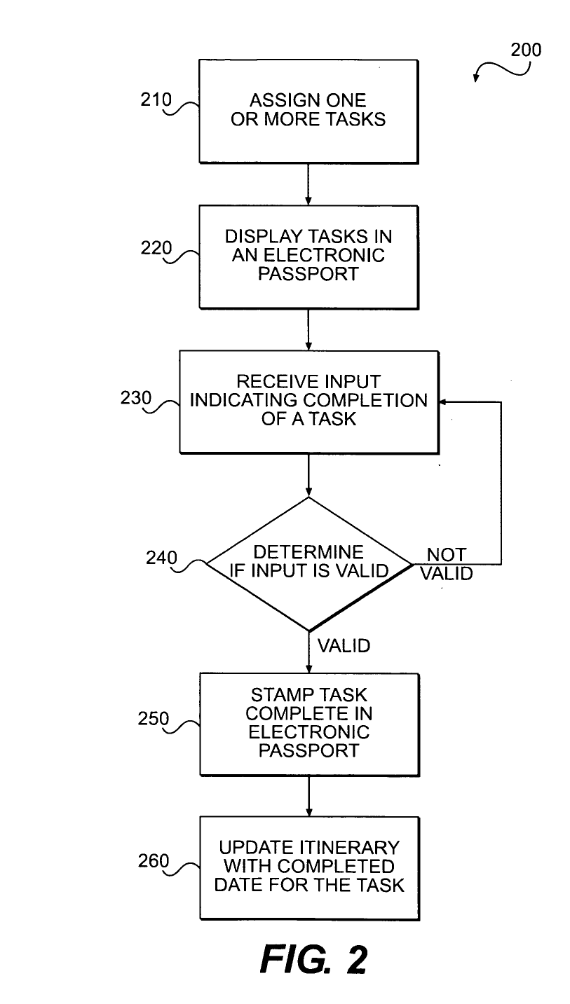

Processes and methods consistent with the disclosed embodiments may provide a simple, easily understood graphical user interface for assigning and monitoring completion of tasks. As a result, managers may monitor the status of tasks assigned to employees, employees may monitor the status of tasks to which they are assigned, and companies may easily update task schedules. Exemplary processes, methods, and user interfaces consistent with the invention will now be described with reference to FIGS. 2-6.

### INDUSTRIAL APPLICABILITY

The disclosed method and system may provide an online task monitoring tool. In particular, the disclosed method and system may be used to implement an online task monitoring tool that guides an employee while performing one or more tasks. The task monitoring tool allows companies and employees to assign tasks and determine the status of tasks. Dealers and companies may perform these exemplary functions of the disclosed task monitoring tool using a simple, intuitive, web-based interface.

FIG. 2 illustrates a flowchart illustration of an exemplary disclosed method 200 performed by a task monitoring tool. The first step in the functioning of the task monitoring tool may include assigning one or more tasks (Step 210). For example, an employee who works in the human resources department may assign a number of tasks to new employees as part of a new employee orientation program. These tasks may include, for example, attending training sessions, selecting benefits packages, and completing a training exercise, as described in more detail below. The tasks may be stored in a file, such as a Microsoft Excel® spreadsheet, and provided from server system 155 to client 105. Although the examples described herein relate to tasks for new employee orientation, the disclosed task monitoring tool may be used to assign and monitor any other series of tasks.

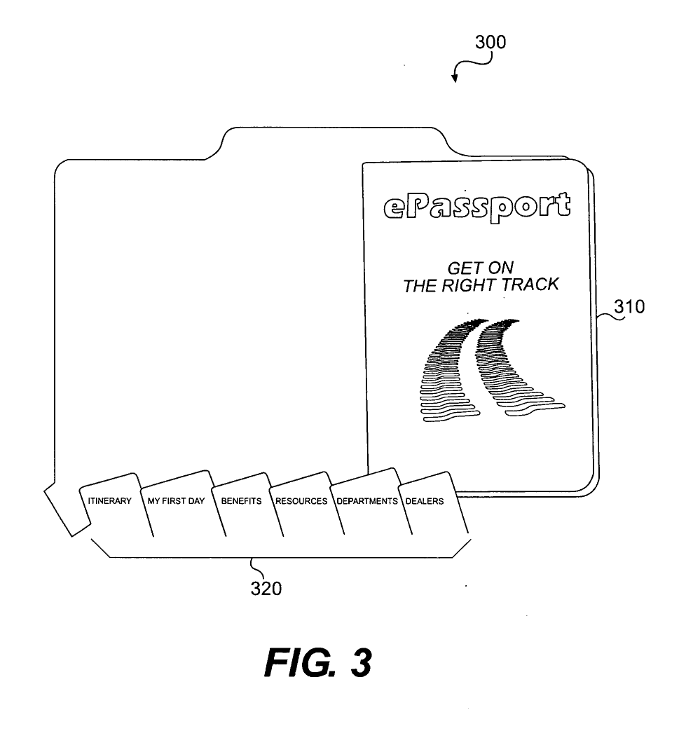

Next, client 105 may display the tasks in an electronic passport (Step 220). The electronic passport may provide a simple, intuitive graphical user interface for completing tasks. An employee may access the electronic passport to retrieve a list of the assigned tasks, complete the tasks, and monitor the status of tasks. The electronic passport may provide the employee with additional information needed to complete the tasks, such as a schedule of training sessions and internet links to documents and forms. Exemplary tasks and schematic diagrams of an electronic passport will be described below with reference to FIGS. 3-6.

After a user receives and completes an assigned task, the employee may provide input to client 105 indicating completion of a task (Step 230). The input may vary depending on the task that was assigned to the user. For example, if a user was required to attend a training session, the user may be provided with a special keyword during the training session. The user may then enter this keyword into the electronic passport as input indicating completion of a task. Other exemplary types of input include answers to one or more questions and the user's initials, although any other type of input may be used to indicate completion of a task.

Client 105 may then determine if the input is valid (Step 240). For example, if the task was to answer a question, the input may be valid only if the user provides the correct answer. Similarly, if the user received a special keyword during a training session, the input may only be valid if the user enters the correct keyword. The input may also be valid if the user achieves a defined score or percentage of correct answers to a series of questions. For example, if a user answers 70% of questions in a survey correct, the input may be valid for that task. However, if the user enters incorrect input, or does not achieve the defined score or percentage of correct answers, the electronic passport may return to displaying tasks (Step 220) or the user may attempt to re-enter the input indicating completion of a task (Step 230). The correct answers may be stored in client 105 or server system 155 in any format, such as an Excel® spreadsheet, and the electronic passport may access these answers to determine whether the input is valid.

If the input is valid, client 105 may stamp the task complete in the electronic passport (Step 250). The stamp may indicate to a user that they successfully completed the task and may include the date of successful completion. In addition, other users, such as a manager, may view the status of tasks to determine when a user has completed the assigned tasks. Although described as stamping the task complete, any other indication that a task is complete may be used, such as sounds or check marks beside the task. An example of stamping a task complete in an electronic passport will be described below.

Next, the electronic passport may update an itinerary with the completed date for the task (Step 260). The electronic passport may include an itinerary that a user may access to view a list of all assigned tasks, including the dates on which the user successfully completed each task. An example of an itinerary with completed dates for tasks will be described below.

FIG. 3 illustrates a schematic diagram of an exemplary user interface 300 of an online task monitoring tool. User interface 300 may have the form of an electronic passport 310. Tabs 320 may provide links to organized groups of tasks in electronic passport 310. A user may select any one of tabs 320 to view the associated portion of electronic passport 310. For example, if a user selects the itinerary tab, the electronic passport 310 may open to the itinerary. Although not illustrated, electronic passport 310 may include additional tabs 320 that organize tasks by the amount of time until the tasks become due (e.g., less than 30 days, 30 to 60 days, more than 60 days). Tabs 320 may be different colors, and the associated pages in electronic passport 310 may be the same color as the tab to confirm to a user which portion of electronic passport 310 is being displayed.

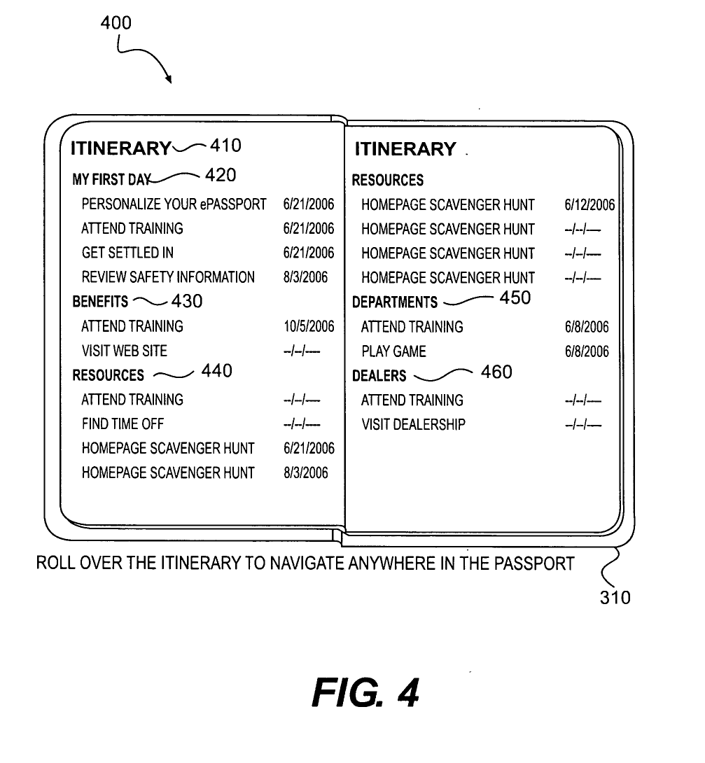

FIG. 4 illustrates an exemplary itinerary 410 provided by electronic passport 310. Itinerary 410 may display all of the tasks that are assigned to a user, and the tasks may be divided into categories. Continuing with the example of new employee orientation tasks, the tasks may be divided into my first day 420, benefits 430, resources 440, departments 450, and dealers 460. A user may select the text in itinerary 410 to navigate to the associated section of electronic passport 310.

My first day 420 may include all of the tasks assigned to an employee for their first day as an employee. An employee may personalize their electronic passport 310 by, for example, entering their name, employee number, start date, and selecting a language to use with electronic passport 310. Electronic passport 310 may prompt the user for this information the first time the user opens electronic passport 310, and the completion date Jun. 21, 2006 may be the date on which the user customizes their electronic passport 310. My first day 420 may also include attending initial training, getting settled in (e.g., meeting other employees, obtaining office supplies, etc.), and reviewing safety information. The user may select each of these items in the itinerary to obtain instructions on completing the task, provide input confirming completion of the task (e.g., a keyword provided during training), and open links to information needed to complete the task. For example, if a user selects to review safety information, electronic passport 310 may provide the user with an internet link to a website that includes an evacuation procedure. Once the user has reviewed the evacuation procedure, the user may provide input to electronic passport 310 confirming that this task is complete. The input may be, for example, the user's initials.

Benefits 430 may include attending benefits training and visiting a benefits website to learn about the benefits offered to new employees. Exemplary benefits include health insurance, retirement plans, dental plans, and discounts on products or services. During training and while visiting the benefits website, a user may watch videos, view tutorials, select benefits (electronically or by paper), and perform other associated tasks. The user may be provided with keywords as input to indicate completion of a task, or may use their initials.

Resources 440 may include tasks designed to familiarize the employee with resources the company offers. These resources may include computer help support from an information technology department, mailing services, facsimile services, employee directories, training manuals, sample forms for completing tasks, and other resources provided by a company. Employees may attending training to learn about the resources that a company offers. With reference to FIG. 4, the user of electronic passport 310 has not yet attended resources training, as indicated by the date being incomplete. Once a user attends resources training and provides valid input to electronic passport 310, the date may be updated with the date the user completed the training. Resources 440 may also include a task of finding time off, which may instruct the user to logon to the company's vacation system. Companies may use a vacation system to track annual and sick leave balances and allow employees to indicate when they will be on vacation.

Resources tasks may also include performing one or more homepage scavenger hunts. A homepage scavenger hunt may include one or more questions that can be answered with information on the homepage of the company. Requiring users to perform homepage scavenger hunts may familiarize employees with the company's website (internet or intranet) and the resources offered by the website. Exemplary questions for a homepage scavenger hunt include identifying a manager for a particular business group, finding information regarding employee discounts, identifying which department is responsible for a certain business task, determining what acronyms stand for, and finding the last four digits of an employee's phone number. The answers to these questions may be stored in an Excel® spreadsheet, allowing an administrator to easily change the questions and answers. Itinerary 410 may be updated with the date on which the user provides valid input for answers to each of the homepage scavenger hunts.

Itinerary 410 may also include departments 450, which may be include one or more tasks that familiarize new employees with the different departments of a company. Large companies may be divided into different departments, such as accounting, human resources, research, product production, and distribution. Employees may attend training to learn about the different departments of a company, and also may play a game that tests the employee's knowledge of company departments. For example, the game may provide a user with a description of a department and the user may identify the department. The game may provide the employee with a keyword to enter into electronic passport 310 once the employee correctly answers the questions in the game. If the user enters the correct keyword into electronic passport 310, the task may be stamped as complete and the itinerary may be updated with the completion date (e.g., Jun. 8, 2006).

Dealers 460 may include tasks designed to familiarize employees with dealers of the company. Many companies sell their products to dealers, and the dealers then sell the products to consumers. Employees may attend training to learn, for example, how dealers place orders for products, where dealers are located, and what types of products dealers sell. Employees may also visit a dealership. Although described as an employee visiting a dealership, the tasks assigned to an employee may familiarize the employee with any type of customer.

After the user has completed all of the tasks in itinerary 410, the user may submit a copy of the itinerary to the person who assigned the tasks. The person may submit the completed itinerary either electronically or by printing a copy and delivering it to the person who assigned the tasks. In this example, the user may submit the completed itinerary to an employee in human resources and receive a reward for completing the tasks. The reward may be, for example, a coupon for a free lunch in the company's cafeteria or a desk ornament.

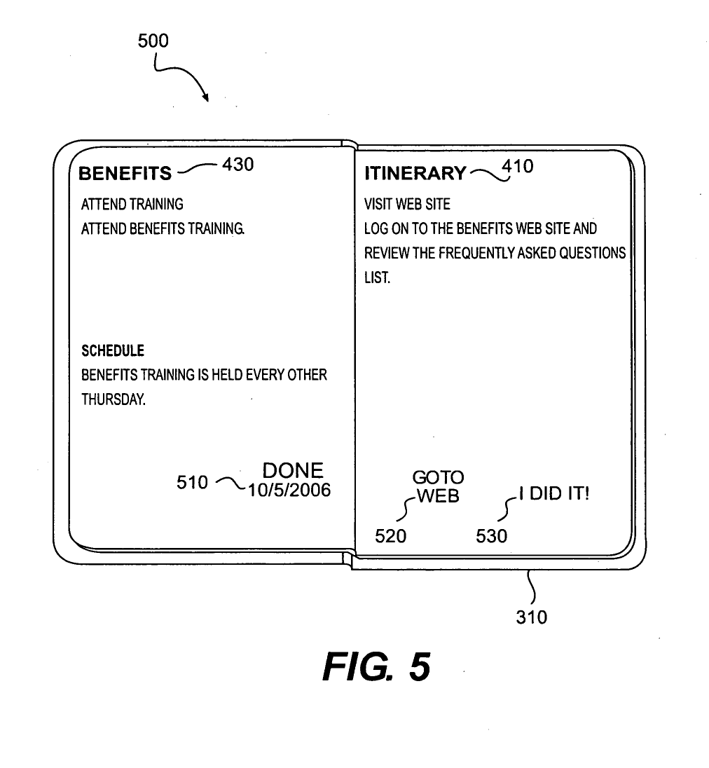

FIG. 5 illustrates a schematic drawing of an exemplary user interface 500 that client 105 may display when a user select benefits 430 from tabs 320 (FIG. 3) or itinerary 410 (FIG. 4). Electronic passport 310 may update itinerary 410 to include an itinerary for benefits tasks and may provide additional information for completing benefits tasks. For example, electronic passport 310 may provide users with the schedule for attending benefits training (e.g., every other Thursday). Once a user attends the training, the user may provide input, such as a keyword received during the training or the user's initials, to indicate completion of the task. If the input is valid, the passport may be stamped “done” 510 to indicate that the user completed the task (e.g., attending benefits training). Stamp 510 may also include the date that the user completed the task (e.g., Oct. 5, 2006).

Another exemplary benefits task is visiting the benefits website. Electronic passport 310 may provide a user with an internet address (not illustrated) and an internet link “Go To Web” 520 for accessing the benefits website, and instructions on what tasks the user should perform using the website (e.g., review the frequently asked questions list). Although not illustrated, link 520 may also link a user to documents, questionnaires, forms, and games used to complete the associated task. Once the user visits the website and reviews the frequently asked questions list, the user may select “I did it!” 530 to indicate completion of the task. A pop-up window may then be displayed that allows the user to provide input confirming completion of the task, such as an answer to a frequently asked question.

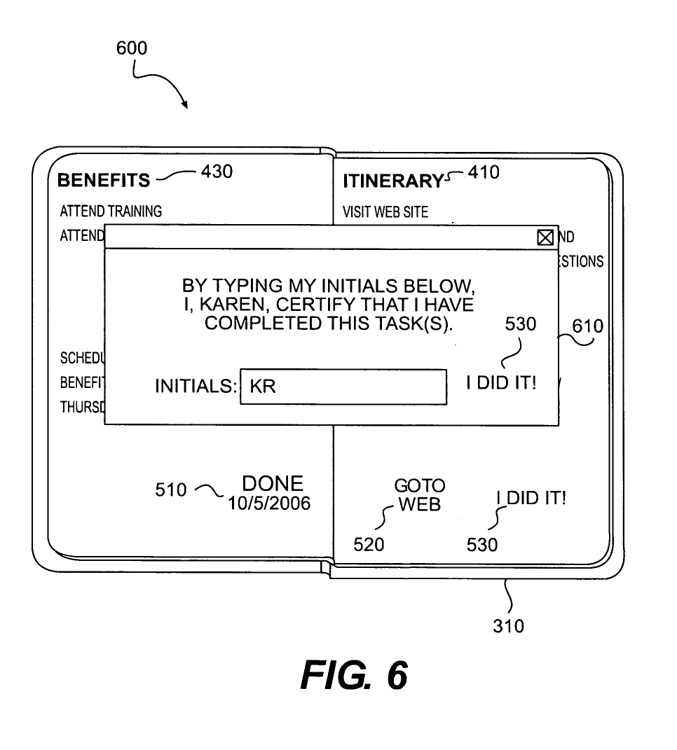

FIG. 6 illustrates an exemplary user interface 600 for providing input to electronic passport 310. Once a user selects “I did it!” 530, electronic passport 310 may display pop-up window 610 to prompt the user for input related to the task. In the example of FIG. 6, the user may simply enter their initials to confirm completion of the task. However, as described above, other forms of input may be required, such as answers to one or more questions. In addition, users may receive confirmation of completing a task from another person's electronic passport 310. For example, if a manager trains an employee for an hour, the manager may provide input to their electronic passport 310 indicating “1 hour of training for John Doe.” Server system 155 may then update John Doe's electronic passport 310 to confirm completion of the training.

The disclosed task monitoring system provides a simple, easy to understand user interface that allows to view, complete, and monitor tasks. Accordingly, companies and their employees can easily assign and track the status of tasks without the need for specialized training.

The files, information, data, and reports described herein may be assembled in any format, such as a spreadsheet (e.g., Excel® or XML files). By using a spreadsheet format, users may easily sort columns, add columns, and otherwise customize tasks.

It will be apparent to those skilled in the art that various modifications and variations can be made to the disclosed methods for monitoring tasks. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A computer-readable medium, tangibly embodied, including a task monitoring tool, the computer-readable medium comprising instructions for:
displaying one or more tasks using an electronic passport;
receiving input indicating completion of the task; and
indicating the task as complete in the electronic passport.

2. The computer-readable medium of claim 1, further including instructions for:
providing an itinerary of the tasks; and
updating the itinerary with a date the task is indicated as complete.

3. The computer-readable medium of claim 2, further including instructions for:
determining whether the input is valid; and
indicating the task as complete when the input is valid by stamping the electronic passport.

4. The computer-readable medium of claim 1, wherein:
the task includes answering one or more questions,
the input includes answers to the questions, and
the input is valid if a defined percentage of the answers are correct.

5. The computer-readable medium of claim 1, wherein the input indicates an amount of time spent on the task.

6. The computer-readable medium of claim 1, further including instructions for providing one or more links to information needed to complete the task.

7. The computer-readable medium of claim 1, wherein the electronic passport includes displayed tabs that link to a related portion of the electronic passport.

8. A method for providing a task monitoring tool, comprising:
displaying one or more tasks using an electronic passport;
receiving input indicating completion of the task; and
identifying the task as complete in the electronic passport.

9. The method of claim 8, further including:
providing an itinerary of the tasks; and
updating the itinerary with a date the task is indicated as complete.

10. The method of claim 9, further including:
determining whether the input is valid; and
indicate the task as complete when the input is valid by stamping the electronic passport.

11. The method of claim 8, wherein:
the task includes answering one or more questions,
the input includes answers to the questions, and
the input is valid if a defined percentage of the answers are correct.

12. The method of claim 8, wherein the input indicates an amount of time spent on the task.

13. The method of claim 8, further including providing one or more links to information needed to complete the task.

14. The method of claim 8, wherein the electronic passport includes displayed tabs that link to a related portion of the electronic passport.

15. A system, comprising:
a platform;
at least one input device; and
at least one central processing unit in communication with the platform and the at least one input device, the central processing unit configured to:
display one or more tasks using an electronic passport;
receive input indicating completion of the task; and
indicate the task as complete in the electronic passport.

16. The system of claim 15, wherein the central processing unit is further configured to:
provide an itinerary of the tasks; and
update the itinerary with a date the task is indicated as complete.

17. The system of claim 16, wherein the central processing unit is further configured to:
determine whether the input is valid; and
indicate the task as complete when the input is valid by stamping the electronic passport.

18. The system of claim 15, wherein:
the task includes answering one or more questions,
the input includes answers to the questions, and
the input is valid if a defined percentage of the answers are correct.

19. The system of claim 15, wherein the input indicates an amount of time spent on the task.

20. The system of claim 15, wherein the central processing unit is further configured to:
provide one or more links to information needed to complete the task; and
display tabs that link to a related portion of the electronic passport.
